(19) United States
(12) Patent Application Publication
(10) Pub. No.: US 2022/0203330 A1
(43) Pub. Date: Jun. 30, 2022

(54) FIBRILLATED BICOMPONENT FIBERS AND METHODS OF MAKING AND USES THEREOF

(71) Applicant: NORTH CAROLINA STATE UNIVERSITY, Raleigh, NC (US)

(72) Inventor: Behnam POURDEYHIMI, Raleigh, NC (US)

(21) Appl. No.: 17/433,629

(22) PCT Filed: Feb. 25, 2020
(86) PCT No.: PCT/US2020/019718

§ 371 Date: Aug. 25, 2021

Related U.S. Application Data
(60) Provisional application No. 62/809,980, filed on Feb. 25, 2019.

(51) Int. Cl. B01J 20/28; B01J 20/26; B01J 20/30; B01D 39/16; D04H 3/007; D04H 3/011; D04H 3/11

(52) U.S. Cl. CPC B01J 20/28038; B01J 20/261; B01J 20/262; B01J 20/3007; B01D 39/1623; D04H 3/007; D10B 2505/04; D04H 3/11; B01D 2239/10; B01D 2239/0627; B01D 2239/0233; B01D 2239/04; B01D 2239/0618; D04H 3/011

(57) ABSTRACT

The subject matter disclosed herein relates generally to microdenier fabrics comprising fibrillated bicomponent fibers. The bicomponent fibers can be fibrillated mechanically by hydroentangling, where the hydroentangling energy is sufficient for fibrillating as well as entangling or bonding the fibers. The bicomponent fibers can have an island-in-the-sea configuration. The micro-denier fabrics can be woven, knitted, or nonwoven. A nonwoven fabric made from the bicomponent fibers can be formed by either spunbonding or through the use of bicomponent staple fibers formed into a web by any one of several means and bonded similarly to those used for the spunbonded filament webs.

### CROSS REFERENCE TO RELATED APPLICATION

This application claims the benefit of priority to U.S. Provisional Application 62/809,980, filed Feb. 25, 2019, which is incorporated by reference herein in its entirety.

### TECHNICAL FIELD

The compositions and methods disclosed herein relate generally to the manufacture of microdenier fibers and nonwoven products manufactured from fibrillated bicomponent fibers.

### BACKGROUND

Nonwoven spunbonded fabrics are used in many applications, especially those requiring a lightweight disposable fabric. Therefore, most spunbonded fabrics are designed for single use. Spunbonding refers to a process whereby fibers or filaments are extruded, cooled, drawn, and subsequently collected on a moving belt to form a web. The web is not bonded and the fibers or filaments must be bonded together thermally, mechanically, or chemically to form a fabric. Thermal bonding is the most efficient and economical means for forming a fabric. Hydroentangling is not as efficient, but it leads to a much more flexible and, normally, stronger fabric when compared to thermally bonded fabrics.

Microdenier fibers are fibers that are smaller than 1 denier. Typically, microdenier fibers are produced utilizing a bicomponent fiber which is split. Splitting a bicomponent fiber allows multiple fibers with a smaller cross sectional area to be produced from one larger filament. The best known type of splittable fiber is commonly referred to as “pie wedge” or “segmented pie.” U.S. Pat. No. 5,783,503 illustrates a typical meltspun muticomponent thermoplastic continuous filament, which is split absent mechanical treatment. In the configuration described, it is desired to provide a hollow core filament. The hollow core prevents the tips of the wedges of like components from contacting each other at the center of the filament and promotes separation of the filament components.

When manufacturing bicomponent fibers for splitting, several characteristics of the fibers are typically required to ensure that the fiber may be adequately manufactured. The affinity between the types of polymers used for the fiber's different components affects the strength of the interface between the components, and therefore affects the ease with which the components can be split. Exemplary combinations of polymers include polyester and polypropylene, polyester and polyethylene, nylon and polypropylene, nylon and polyethylene, and nylon and polyester. Since these bicomponent fibers are spun in a segmented cross-section, each component is exposed along the length of the fiber. Consequently, if the components selected do not have properties which are closely analogous, the fiber may suffer defects during manufacturing such as breaking, or crimping, or wrapping. Such defects would render the fiber unsuitable for further processing. The mechanical properties of the polymers used for the components are also important, as they affect the processing of the fibers and the mechanical properties of fabrics made from the fibers, such as tensile strength and tear strength.

U.S. Pat. No. 6,448,462 discloses another multicomponent filament having an orange-like multisegment structure representative of a pie configuration. This patent also discloses a side-by-side configuration. In these configurations, two incompatible polymers such as polyesters and a polyethylene or polyamide are utilized to form a continuous multicomponent filament. These filaments are melt-spun, stretched and directly laid down to form nonwoven fabrics.

The segmented pie is only one of many possible splittable configurations. In the solid form, it is easier to spin, but in the hollow form, it is easier to split. To ensure splitting, dissimilar polymers are utilized. But even after choosing polymers with low mutual affinity, the fiber's cross section can have an impact on how easily the fiber will split. The cross section that is most readily splittable is a segmented ribbon. The number of segments has to be odd so that the same polymer is found at both ends so as to “balance” the structure. This fiber is anisotropic and is difficult to process as a staple fiber. As a filament, however, it would be acceptable in the spunbonding process.

Another challenge of using segmented pie configurations is that the overall fiber shape upon splitting is a wedge. This configuration is a direct result of the process of producing the small micro-denier fibers. Consequently, while suitable for their intended purpose, other shapes of fibers may be desired, which produce advantageous application results. Such shapes are currently unavailable under standard segmented processes.

Another method of creating microdenier fibers utilizes fibers of the island-in-the-sea configuration. U.S. Pat. No. 6,455,156 discloses one such structure. In an island-in-the-sea configuration a primary fiber component, the sea, is utilized to envelope smaller interior fibers, the islands. Such structures provide for ease of manufacturing but require the removal of the sea in order to reach the islands. This is done by dissolving the sea in a solution which does not impact the islands. Since it is necessary to extract the island components, the method restricts the types of polymers which may be utilized in that they are not affected by the sea removal solution. In addition, the process of removing the islands is not environmentally sound because of the use of solvents to remove the sea.

Such island-in-the-sea staple fibers are commercially available today. They are most often used in making synthetic leathers and suedes in a dry lay process such as carding. Another end-use that has resulted in much interest in such fibers is in technical wipes, where the small fibers lead to a large number of small capillaries resulting in better fluid absorbency and better dust pick-up. For a similar reason, such fibers are of interest in filtration.

Pourdeyhimi, et.al., developed processes for fibrillating islands-in-the-sea fibers where the sea is fractured and/or fibrillated by hydroentangling. The sea remains an integral part of the structure and eliminates the need for removing the sea chemically (U.S. Pat. Nos. 7,981,226; 8,420,556; 7,883,772; 7,981,336; 8,349,232). These fibrillated structures however, lacked uniformity and were not always fully fibrillated. Consequently, their properties for filtration were less than optimal.

A publication dealing with fibrillated islands-in-the-sea entitled “Aerosol filtration properties of PA6/PE islands-in-the-sea bicomponent spunbond web fibrillated by high-pressure water jets” in the Journal of Materials Science 46(17), 5761-5767, indicated that high efficiency filters were not produced by this technology, and that it was necessary to charge the filters to increase their efficiency.

A normal spunbond with the fibers in the range of 10 to 20 microns also cannot have high efficiency filtration. A publication entitled “A case study of simulating submicron aerosol filtration via lightweight spun-bonded filter media,” Chemical Engineering Science, 61(15), 4871-4883, also showed that only about 8% efficiency would be possible for such structures.

In summary, what has been accomplished so far has limited application for filtration specifically because of the limitations of fully fibrillating these fibers, and therefore, mixtures of unfibrillated and fibrillated fibers would provide for local non-uniformities that would lead to low filtration properties.

Accordingly, there is a need for a manufacturing process that can produce micro-denier fiber dimensions uniformly and completely in a manner which is conducive to spunbond processing and which is environmentally sound. Fibrillated fibers produced by such methods and articles prepared from them are also needed. The compositions and methods disclosed herein address these and other needs.

### SUMMARY

In accordance with one embodiment of the present subject matter, methods for producing bicomponent filaments are disclosed wherein the bicomponent filaments comprise islands-in-the-sea fibers including a low amount of external “sea” component. In certain embodiments, the fibers include a sea component from 5% to 15% of the fiber. Also, disclosed are methods of fibrillating such fibers by hydroentangling. Because the sea components in the fibers are relatively thin, they can be easily and fully fibrillated using lower energy. Further, the surface of the drum used in hydroentangling can be smooth, which allows the separation of the fibrils after fibrillation. Thus, the islands do not remain as bundles as in previously developed microfiber spunbonds.

The materials used for the external fiber component and the internal fiber component should be incompatible to facilitate fibrillation. An additive may also be used to improve fibrillation.

Another aspect disclosed herein provides methods for producing a micro-denier fabric. In certain embodiments, the micro-denier fabric is a nonwoven fabric.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The invention will be more readily understood from a reading of the following specification and by reference to the accompanying drawings forming a part thereof:

FIG. 1 depicts a typical bicomponent spunbonding process.

FIG. 2 shows a typical process for hydroentangling.

FIG. 3 shows an islands-in-the-sea bicomponent fiber.

FIG. 4 depicts examples of 108 islands-in-the-sea bicomponent fibers produced by spunbonding.

FIGS. 5, 6 and 7 show examples of PP/PLA fibers with 37 islands and a sea content of 15%.

### DETAILED DESCRIPTION

The present invention now will be described more fully hereinafter with reference to the accompanying drawings, in which some, but not all embodiments of the inventions are shown. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

Many modifications and other embodiments of the invention set forth herein will come to mind to one skilled in the art to which this invention pertain having the benefit of the teachings presented in the descriptions herein and the associated drawings. Therefore, it is to be understood that the inventions are not to be limited to the specific embodiments disclosed and that modifications and other embodiments are intended to be included within the scope of the appended claims.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and claims, the singular forms “a”, “an”, and “the” include plural referents unless the context clearly indicates otherwise. For example, reference to “a fiber” includes a plurality of such fibers.

Where a range of values is provided, it is understood that each intervening value, to the tenth of the unit of the lower limit unless the context clearly dictates otherwise, between the upper and lower limit of that range and any other stated or intervening value in that stated range, is encompassed. The upper and lower limits of these smaller ranges may independently be included in the smaller ranges, and are also encompassed, subject to any specifically excluded limit in the stated range. Where the stated range includes one or both of the limits, ranges excluding either or both of those included limits are also included.

As used herein, a “staple fiber” means a fiber of finite length. A staple fiber can be a natural fiber or a fiber cut from, for example, a filament.

As used herein, a “filament” refers to a fiber that is formed into a substantially continuous strand.

As used herein, a “nonwoven fabric” means a fabric having a structure of individual fibers or filaments that are interlaid but not necessarily in an identifiable manner as with knitted or woven fabrics.

As used herein, “needle punching” means to mechanically entangle a web of either non-bonded or loosely bonded fibers by passing barbed needles through the fiber web.

As used herein, the terms “hydroentangle” or “hydroentangling” refers to a process by which a high velocity water jet or even an air jet is forced through a web of fibers causing them to become randomly entangled. Hydroentanglement can also be used to impart images, patterns, or other surface effects to a nonwoven fabric by, for example, hydroentangling the fibers on a three-dimensional image transfer device such as that disclosed in U.S. Pat. No. 5,098,764 to Bassett et al. or a foraminous member such as that disclosed in U.S. Pat. No. 5,895,623 to Trokhan et al., both fully incorporated herein by reference for their teachings of hydroentanglement.

As used herein, the terms “calender” or “calendering” refers to a process for imparting surface effects onto fabrics or nonwoven webs. Without intending to be limiting, a fabric or nonwoven web can be calendered by passing the fabric or nonwoven web through two or more heavy rollers, sometimes heated, under high nip pressures.

It is understood that throughout this specification, the identifiers “first” and “second” are used solely to aid in distinguishing the various components and steps of the disclosed subject matter. The identifiers “first” and “second” are not intended to imply any particular order, amount, preference, or importance to the components or steps modified by these terms. Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

### Materials

The subject matter disclosed herein relates to methods for fibrillating filaments. The basis for these methods is the formation of a bicomponent filament that includes an external fiber component that envelopes an internal fiber component. Preferably, the internal fiber component comprises a plurality of fibers, and the filament is of an island-in-the-sea configuration.

In certain embodiments, the methods disclosed herein further relate to the manufacturing of microdenier fabrics from bicomponent filaments. The microdenier fabrics can be woven, knitted, or nonwoven. In certain embodiments, the methods disclosed herein further relate to the manufacturing of nonwoven fabrics by spunbonding or through the use of bicomponent staple fibers formed into a web by any one of several means such as wetlay, drylay, etc., and bonded similarly to those used for the spunbonded filament webs.

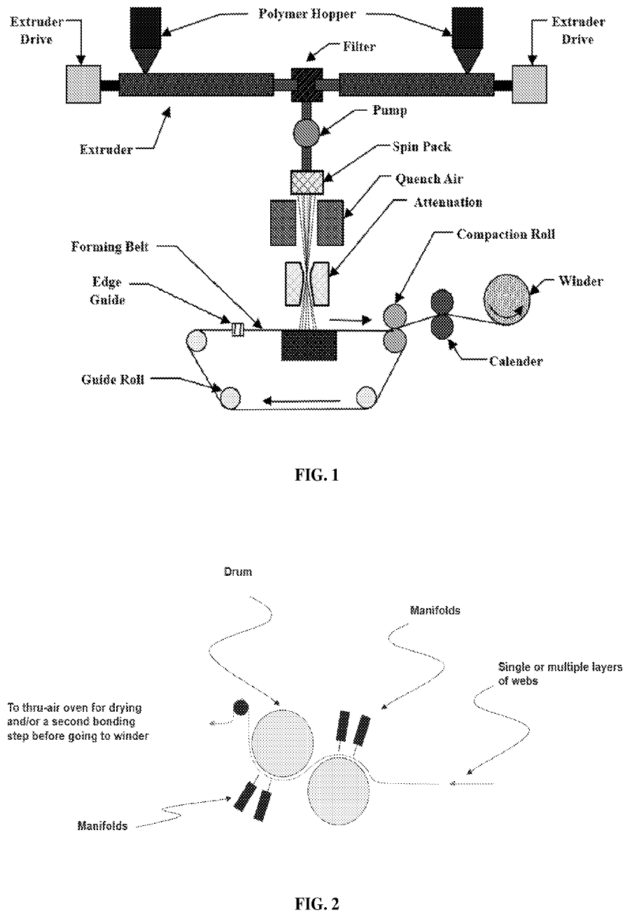

FIG. 1 shows an example of a typical bicomponent filament spunbonding process. Polymer is fed from a hopper into an extruder. The polymer is heated in the extruder, melting the polymer. The polymer can be mixed with additives in the extruder. The molten polymer passes through a filter and into a pump. The polymer then moves into the spin pack which contains a spinneret. The spinneret has holes that form the molten polymer into fibers or filaments. Quench air cools the polymer, causing the polymer to solidify. In attenuation, the polymer filaments are stretched, orienting the molecules in the polymer.

In the exemplary process shown in FIG. 1, the polymer filaments are deposited on a forming belt to form a web. The web then passes through a compaction roll and a calender, which bonds the filaments together to form a fabric. Bonding methods used in spunbonding processes can include hydroentangling, needlepunching, thermal bonding, and other methods.

FIG. 2 shows a typical process for hydroentangling. FIG. 2 shows a drum entangler using two drums and four injectors. A pre-wet injector/manifold may be used as well, and there may be more drums and injectors used.

Preferably, the methods disclosed herein for producing a nonwoven fabric include spinning a set of bicomponent filaments which includes an external fiber component and an internal fiber component, wherein the external fiber component enwraps the internal fiber component. In some embodiments, the external fiber component only partially enwraps the internal fiber component, leaving at least part of the internal fiber component exposed. In specific embodiments, the external fiber component does not wrap the internal component. For example, the methods disclosed herein include producing an islands-in-the-sea bicomponent filament having multiple internal fiber components and an external fiber component.

In certain embodiments, the bicomponent filament comprises an island-in-the-sea fiber having from 2 to 1000 islands (internal components). In certain embodiments, the bicomponent fiber has from 30 to 40 islands. In other embodiments, the bicomponent fiber has from 2 to 100 islands, 100 to 200 islands, 300 to 400 islands, 400 to 500 islands, 500 to 600 islands, 600 to 700 islands, 700 to 800 islands, 800 to 900 islands, 900 to 1000 islands, 10 to 80 islands, 20 to 60 islands, or 30 to 50 islands.

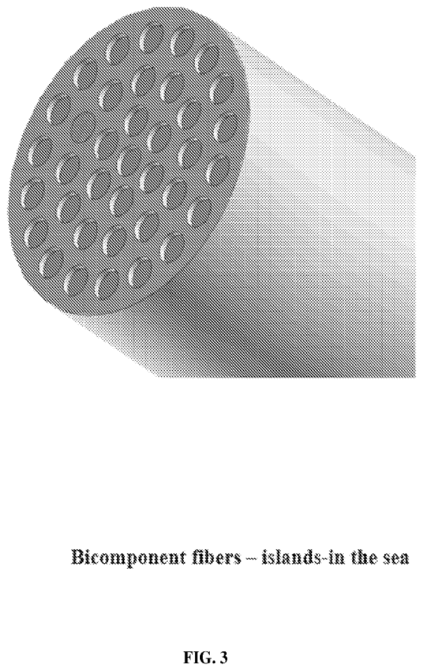

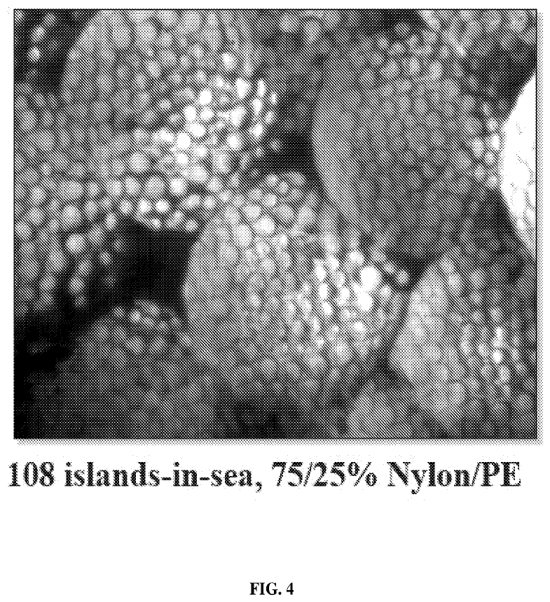

FIG. 3 shows a typical islands-in-the-sea bicomponent filament. The “islands” internal fiber components are enwrapped in the “sea” external fiber component. The islands in FIG. 3 have a circular cross-section. FIG. 4 shows an islands-in-the-sea fiber with 108 islands. The ratio of islands to sea in the fiber shown in FIG. 4 is 75/25%. The fibers shown in FIG. 4 were produced by a spunbonding process.

In the methods disclosed herein, the internal fiber component can be produced having a non-round cross-section. Such cross-section may be multi-lobal or round. In certain embodiments, the internal fiber component comprises a thermoplastic polymer wherein said thermoplastic polymer is a copolyetherester elastomer with long chain ether ester units and short chain ester units joined head to tail through ester linkages. In certain embodiments, the internal fiber component can comprise a thermoplastic polymer selected from the group consisting of nylon 6, nylon 6/6, nylon 6/10, nylon 6/11, nylon 6/12, nylon 11, nylon 12, polypropylene or polyethylene, polyesters, co-polyesters or other similar thermoplastic polymers. In certain embodiments, the internal fiber component can comprise a thermoplastic polymer selected from the group consisting of polyesters, polyamides, thermoplastic copolyetherester elastomers, polyolefins, polyacrylates, and thermoplastic liquid crystalline polymers.

In certain embodiments, the external fiber component comprises a thermoplastic polymer wherein said thermoplastic polymer is a copolyetherester elastomer with long chain ether ester units and short chain ester units joined head to tail through ester linkages. In certain embodiments, the external fiber component comprises a thermoplastic polymer selected from the group consisting of nylon 6, nylon 6/6, nylon 6/10, nylon 6/11, nylon 6/12, nylon 11, nylon 12, polypropylene or polyethylene. In certain embodiments, the external fiber component comprises a thermoplastic polymer selected from the group consisting of polyesters, polyamides, thermoplastic copolyetherester elastomers, polyolefins, polyacrylates, and thermoplastic liquid crystalline polymers.

During fibrillation, the external fiber component, or sea, is fractured. Thus, the sea component can remain in the finished nonwoven fabric instead of being removed by dissolving or other methods. Leaving the sea component in the finished nonwoven fabric has multiple advantages, including reducing the cost of production and being more environmentally sound because solvents are not needed to dissolve the sea. Preferably, the material of the external fiber component has low adhesion to the material of the internal fiber component, which facilitates fibrillation. If the amount of adhesion between the external fiber component and the internal fiber component is too high, the fibers produced may not be fully fibrillated or may lack uniformity. Nonwoven fabrics that are not fully fibrillated or that lack uniformity may not be optimal for filtration and other applications. If the interface between the internal fiber component and the external fiber component is incompatible, fibrillation will be more uniform and complete.

The compatibility between the fiber components is measured by the chi factor (x) or the solubility parameter of the two polymers used. At the temperatures at which the polymers are processed, there can be chemical interactions between the two polymers, which can affect the interface between the polymer components.

In the bicomponent filament, the external fiber component comprises from 5%-30% of the total fiber for ease of fibrillation. In some embodiments, the external component is less than 20% of the total fiber. In one embodiment, the external component is 10% of the total fiber. In other embodiments, the external fiber component is 5%-10%, 6%-10%, 7%-10%, 8%-10%, 9%-10%, 5%-15%, 6%-15%, 7%-15%, 8%-15%, 9%-15%, 10%-15%, 11%-15%, 12%-15%, 13%-15%, 14%-15%, 15%, 5%-25%, 10%-25%, 15%-25%, or 15%-30%.

In certain embodiments, the external sea component does not entirely enwrap the internal islands components. In certain embodiments, for example when the sea component is less than 20% of the total fiber, the sea forms a thin barrier between the islands due to the low amount of external sea component. This increases the ease of fibrillation. In certain embodiments, the sea enwraps the islands less than 90%. In certain embodiments, the sea enwraps the islands less than 75%, less than 70%, less than 65%, less than 60%, less than 55%, less than 50%, from 1% to 90%, 10% to 90%, 20% to 90%, 30% to 90%, 40% to 90%, 50% to 90%, 60% to 90%, 70% to 90%, or 80% to 90.

Further, adding an oil additive to the bicomponent fibers can facilitate fibrillation. The oil can be up to 15% by mass of a polymer modifier such as a polyolefin fluid. These polymer modifiers are used to enhance the processing of the polymers. The additive makes the interface between the internal and external fiber components less defined, which facilitates fibrillation. In an embodiment, an oil additive is added to a polypropylene fiber component.

Preferably, the fibrillation process utilizes hydro energy for fibrillating the external fiber component. The hydro energy used for fibrillation is also sufficient for hydroentangling the set of bicomponent fibers. The hydroentanglement process typically occurs after the bicomponent fibers have been positioned onto a belt carrier in the form of a web. The process produces micro-denier fibers which can be from 0.1 and 5 microns in diameter. In certain embodiments, the diameter is from 0.1 and 0.5 microns, 0.5 and 1 microns, 1 and 1.5 microns, 1.5 and 2 microns, 2 and 2.5 microns, 2.5 and 3 microns, 3 and 3.5 microns, 3.5 and 4 microns, 4 and 4.5 microns, 4.5 and 5 microns, 0.1 and 1 microns, 0.1 and 2 microns, 0.1 and 3 microns, 0.1 and 4 microns, 1 and 5 microns, 2 and 5 microns 3 and 5 microns, or 4 and 5 microns.

The web or the nonwoven fabric can be exposed to one or more hydroentangling manifolds to fibrillate and hydroentangle the fiber components. The web or nonwoven fabric can have a first surface and a second surface. In certain embodiments, the first surface is exposed to water pressure from one or more hydroentangling manifolds. In other embodiments, the first surface and second surface are exposed to water pressure from one or more hydroentangling manifolds. The one or more hydroentangling manifolds can have a water pressure from 10 bars to 1000 bars. Preferably, the water pressure used for hydroentanglement can be from 10 bars and 500 bars. In certain embodiments, the water pressure used for hydroentanglement is from 10 bars to 100 bars, 10 bars to 200 bars, 10 bars to 300 bars, 10 bars to 400 bars, 10 bars to 600 bars, 100 bars to 200 bars, 300 bars to 400 bars, 500 bars to 600 bars, 600 bars to 700 bars, 700 bars to 800 bars, 800 bars to 900 bars, 900 bars to 1000 bars, or 500 bars to 1000 bars.

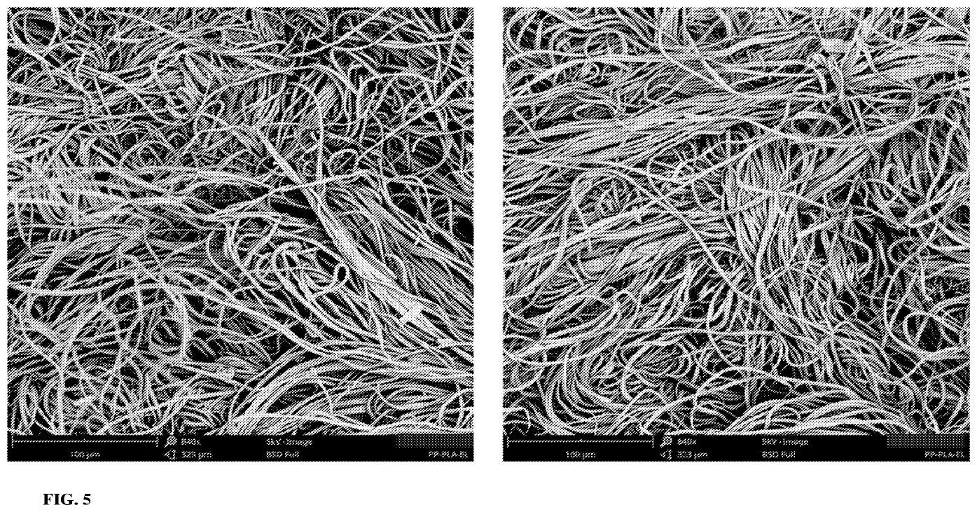

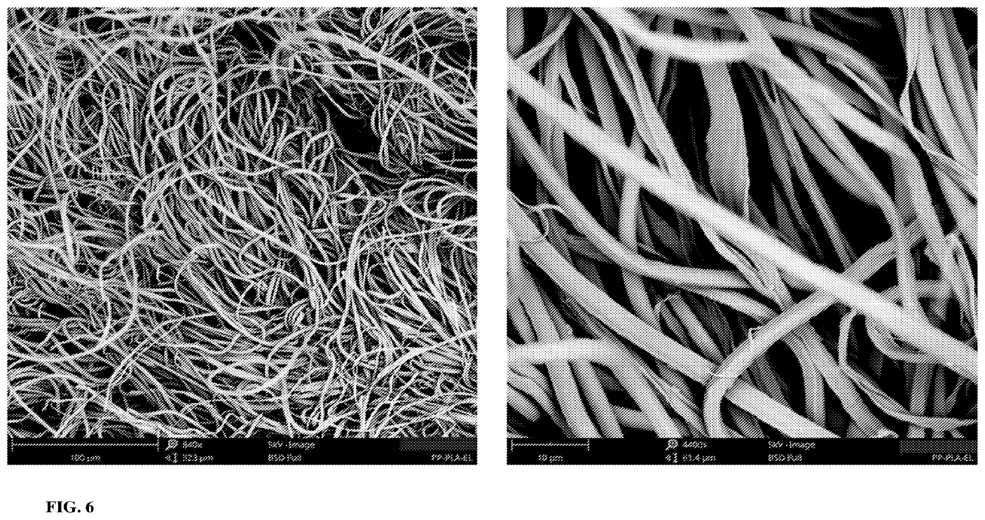

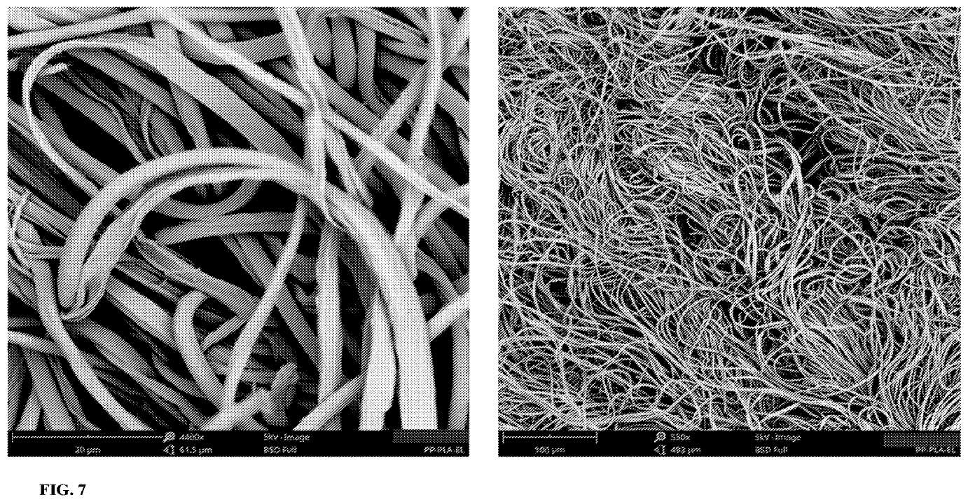

FIGS. 5, 6, and 7 show nonwoven fabrics made from fibrillated bicomponent filaments, as described herein. The sea is fully fibrillated and the islands are dispersed. The smaller flat fibrils are the sea after fracturing or fibrillation. The fibers shown in FIGS. 5, 6, and 7 are all made from a polypropylene islands and PLA. The sea can be other thermoplastics such as polyesters, co-polyester, polyamides, etc. These polymer combinations are effective when there is a need to split the fibers mechanically. The islands account for 85% to 95% of the total mass of the fiber, while the sea is only 15% to 5%. In an embodiment, the sea is about 10% of the total mass of the fiber. The islands can be made from PLA and the sea can be made from polypropylene. In other words, the island and the sea polymers can be switched. Further, adding an oil additive to the polypropylene facilitates fibrillation.

By fibrillating the external fiber component, a nonwoven fabric comprising microfibers or nanofibers can be produced which can be used in high efficiency filters. The structure can also be used in wipes, cleaning cloths, and textiles which are durable and have good abrasion resistance.

High efficiency filters are those capable of capturing particles 0.3 microns or lower. The Minimum Efficiency Rating Value (MERV) set by ASHRAE defines high efficiency as filters that start at MERV 13 or higher, where MERV 16 has up to 95% capture efficiency for particles in the range of 0.3 to 1 micron. These correspond to the European standards of F7, F8 and H11.

Standards for HEPA (High efficiency particulate air) and ULPA (Ultra high efficiency particulate air) filters are set by ISO. These are set as ePM1.0, ePM5.0 and ePM10.

The ISO standard also requires that the electret charge be removed so that only mechanical efficiency is reported. Currently, there are no synthetic media that can meet the mechanical filtration requirements of ePM 1.0 or ePM5.0 standards. Only charged synthetic media and glass media can meet these standards.

In rating filters, three attributes are considered: 1) efficiency, 2) pressure drop (resistance to air flow), and 3) dust holding capacity that defines the life of the filter. In high efficiency filters, only the first two attributes are considered, because pre-filters are normally deployed ahead of the HEPA and ULPA filters.

A glass media for example would capture 99.97% of particles at 0.3 microns at a pressure drop of 500 Pa. A charged media would have a lower pressure drop, but the charge is often not stable. This is why the European standards and the ISO insist on discharging filters and only reporting the mechanical filtration properties.

A PP/PLA fabric produced by the disclosed methods can meet or exceed these standards and match or exceed the performance of glass media at a lower pressure drop.

### EXAMPLES

Several examples are given below demonstrating the properties of the fabrics produced. All fabrics weighed about 80 and 100 g/m². These fabrics were produced as a spunbond web and then subsequently hydroentangled.

### Example 1. 85% PP/5% PLA—Fully Fibrillated 37 Islands by Using 12 Injectors Utilizing Jet Strips in Hydroentangling where the Jets are Spaced 600 Microns Apart

These fabrics report an ePM1.0 mechanical efficiency of 99.0% at a pressure drop of 350 Pa.

### Example 2. 90% PP/10% PLA—Fully Fibrillated 37 Islands by Using 12 Injectors Utilizing Jet Strips in Hydroentangling where the Jets are Spaced 1200 Microns Apart

These fabrics report an ePM1.0 efficiency of mechanical 90.0% at a pressure drop of 65 Pa.

### Example 3. 85% PP/15% PLA—Fully Fibrillated 37 Islands by Using 18 Injectors Utilizing Jet Strips in Hydroentangling where the Jets are Spaced 600 Microns Apart

These fabrics report an ePM1.0 mechanical efficiency of 99.0% at a pressure drop of 350 Pa.

One of the challenges with glass media is that the fabrics are brittle and prone to damage during pleating/processing. In contrast, the fabrics made using the methods disclosed herein can be cleaned and re-used as filters. This is partly due to their flexible nature and their relative strength compared to glass. They can withstand the process with no damage and the filters can be laundered to clean them for re-use.

1. A method for fibrillating a bicomponent filament, comprising:
providing a bicomponent filament having an external fiber component and an internal fiber component; wherein the external fiber component at least partially enwraps the internal fiber component; and wherein the external fiber component is 5% to 25 wt. % of the filament; and
fibrillating the filament, thereby exposing the internal fiber component.

2. The method of claim 1, wherein fibrillating the filament is through hydroentangling.

3. The method of claim 1, further comprising contacting the filament with an oil additive.

4. A method for producing a nonwoven fabric, comprising:
forming a web comprising a bicomponent filament having an external fiber component and an internal fiber component; wherein the external fiber component enwraps the internal fiber component; and wherein the external fiber component is 5% to 25 wt. % of the filament, and an additive that reduces polymer-polymer adhesion; and
hydroentangling the web, thereby producing a nonwoven fabric with fibrillated fibers.

5. The method of claim 4, wherein hydroentangling exposes the nonwoven fabric to water pressure from one or more hydroentangling manifolds at a water pressure between 10 bars and 500 bars.

6. The method of claim 4, wherein the web comprises a first surface and a second surface, and wherein the first surface of the web is exposed to the hydroentangling.

7. The method of claim 6, wherein the second surface of the web is exposed to hydroentangling.

8. The method of claim 4, further comprising pressing the web in an unheated set of rollers.

9. The method of claim 4, wherein the internal fiber component comprises a thermoplastic polymer.

10. The method of claim 9, wherein the thermoplastic polymer is a copolyetherester elastomer with long chain ether ester units and short chain ester units joined head to tail through ester linkages.

11. The method of claim 9, wherein the thermoplastic polymer is selected from nylon 6, nylon 6/6, nylon 6/10, nylon 6/11, nylon 6/12, nylon 11, nylon 12, polypropylene or polyethylene.

12. The method of claim 9, wherein the thermoplastic polymer is selected from polyesters, polyamides, thermoplastic copolyetherester elastomers, polyolefins, polyacrylates, PHA, PHB, PBS, PLA, and thermoplastic liquid crystalline polymers.

13. The method of claim 4, wherein the external fiber component comprises a thermoplastic polymer.

14. The method of claim 13, wherein the thermoplastic polymer is a copolyetherester elastomer with long chain ether ester units and short chain ester units joined head to tail through ester linkages.

15. The method of claim 13, wherein the thermoplastic polymer is selected from nylon 6, nylon 6/6, nylon 6/10, nylon 6/11, nylon 6/12, nylon 11, nylon 12, polypropylene or polyethylene.

16. The method of claim 13, wherein the thermoplastic polymer is selected from polyesters, polyamides, thermoplastic copolyetherester elastomers, polyolefins, polyacrylates, PHA, PHB, PBS, PLA, and thermoplastic liquid crystalline polymers.

17. The method of claim 4, wherein the additive comprises a polyolefin fluid.

18. The method of claim 4, wherein the bicomponent filament includes up to 15 wt. % of the polyolefin fluid additive.

19. The method of claim 4, wherein the bicomponent filament is an islands-in-the-sea fiber with 2 to 1000 islands.

20. The method of claim 4, wherein the bicomponent filament is an islands-in-the-sea fiber with 30 to 40 islands.

21. The method of claim 4, wherein the internal fiber component comprises fibers having round cross-sections.

22. The method of claim 4, wherein the internal fiber component comprises fibers having non-round or multi-lobal cross-sections.

23. A nonwoven fabric comprising:
at least one bicomponent filament comprising
an external fiber component;
an internal fiber component; and
an oil additive;
wherein the external fiber component enwraps the internal fiber component;
wherein the external component is 5 to 15 wt. % of the nonwoven fabric; and
wherein the at least one bicomponent filament is hydroentangled, fibrillating the external fiber component and exposing the internal fiber component.

24. A filter comprising:
a nonwoven fabric made from at least one bicomponent filament comprising
an external fiber component;
an internal fiber component; and
an oil additive;
wherein the external component is 5% to 15% of the nonwoven fabric by mass; and
wherein the at least one bicomponent filament is hydroentangled, fibrillating the external fiber component and exposing the internal fiber component.
